(19) United States
(12) Patent Application Publication
(10) Pub. No.: US 2025/0049063 A1
(43) Pub. Date: Feb. 13, 2025

(54) CONFECTION

(71) Applicant: BANDAI CO., LTD., Tokyo (JP)

(72) Inventors: Yuta KATANO, Tokyo (JP); Yuka TSUCHIDA, Tokyo (JP)

(21) Appl. No.: 18/607,505

(22) Filed: Mar. 17, 2024

(30) Foreign Application Priority Data
Aug. 8, 2023 (JP) 2023-129617
Aug. 8, 2023 (JP) 2023-129618

(51) Int. Cl. A23G 3/54

(52) U.S. Cl. CPC A23G 3/54; A23V 2002/00

(57) ABSTRACT

A confection includes a main body having a plate shape, a character section formed in the main body, and a background section formed in the main body. The background section includes a first background portion having a thickness equal to the thickness of the character section and a second background portion having a thickness different from the thickness of the character section. The plate-shaped confection provided with the character section, by including the first background portion and the second background portion that have plural thicknesses, enables three-dimensional presentation.

### CROSS REFERENCES TO RELATED APPLICATIONS

The present invention contains subject matter related to Japanese Patent Application No. 2023-129617 filed in the Japan Patent Office on Aug. 8, 2023 and Japanese Patent Application No. 2023-129618 filed in the Japan Patent Office on Aug. 8, 2023, the entire contents of which are incorporated herein by reference.

### BACKGROUND OF THE INVENTION

### 1. Field of the Invention

The present invention relates to a confection.

### 2. Description of the Related Art

As a known confection, for example, Japanese Unexamined Utility Model (Registration) application Publication No. 63-061289 discloses a configuration of a puzzle chocolate. Molten chocolate is poured into a mold and is solidified into a chocolate confection having a peripheral shape following the inside of the mold, a surface having three-dimensional shape and pattern shaped along a bottom surface inside the mold, and a required thickness. The chocolate confection is divided, on plane, into the required number of pieces by using scratched cutting lines that are provided so as to cross one another vertically and horizontally at required spacings.

### SUMMARY OF THE INVENTION

Japanese Unexamined Utility Model (Registration) application Publication No. 63-061289 discloses, in chocolate confectionery, such a chocolate formed into a puzzle by providing the scratched cutting lines. However, because there is the only way to play, that is, for example, dividing a predetermined design into pieces along the scratched cutting lines and assembling the divided pieces into the original design, there are a few types of play and a little variety of, for example, taste. Thus, the confection has a problem in attraction.

Accordingly, it is an object of the present invention to provide a confection with improved attraction.

A confection of an embodiment of the present invention includes a main body having a plate shape, a character section formed in the main body, and a background section formed in the main body. The background section includes a first background portion having a thickness equal to a thickness of the character section and a second background portion having a thickness different from the thickness of the character section.

A confection of an embodiment of the present invention includes a main body having a plate shape, a character section formed in the main body and including plural parts, and a background section formed in the main body. The background section includes a first background portion having a thickness equal to a first thickness and a second background portion having a thickness equal to a second thickness that is different from the first thickness. A portion of the plural parts is formed continuously from the second background portion.

According to the present invention, a confection with improved attraction can be provided.

### BRIEF DESCRIPTION OF THE DRAWINGS

FIG. 1 is a plan view of a confection of an embodiment of the present invention;

FIG. 2 is a perspective view of the confection in FIG. 1;

FIG. 3 is a sectional view of a portion along line III-III in FIG. 1;

FIG. 4 is a sectional view of a portion along line IV-IV in FIG. 1;

FIG. 5 is a plan view illustrating a state in which a main body is divided into pieces and illustrating a third aspect that is a failure example of the dividing and the breaking off of a character section;

FIG. 6 is a plan view illustrating a state in which the main body is divided into pieces and illustrating a second aspect that is a failure example of the dividing and the breaking off of the character section;

FIG. 7 is a plan view illustrating a state in which the main body is divided into pieces and illustrating a first aspect when the dividing and the breaking off of the character section have succeeded;

FIGS. 8A and 8B are each a perspective view of a packaging form of the confection, that is, FIG. 8A is a perspective view of the appearance of the packaging form, and FIG. 8B is a perspective view of the inside of the packaging form;

FIG. 9 is a perspective view illustrating a state when the confection is taken out;

FIG. 10 is a plan view of a confection according to an embodiment of the present invention;

FIG. 11 is a perspective view of the confection in FIG. 10;

FIG. 12 is a sectional view of a portion along line XII-XII in FIG. 10;

FIG. 13 is a sectional view of a portion along line XIII-XIII in FIG. 10; and

FIG. 14 is a plan view illustrating an aspect when the dividing and the breaking off of a character section have succeeded with a main body being divided into pieces.

### DESCRIPTION OF THE PREFERRED EMBODIMENTS

### First Embodiment

Hereinafter, a confection that is an embodiment of the present invention will be described with reference to the drawings.

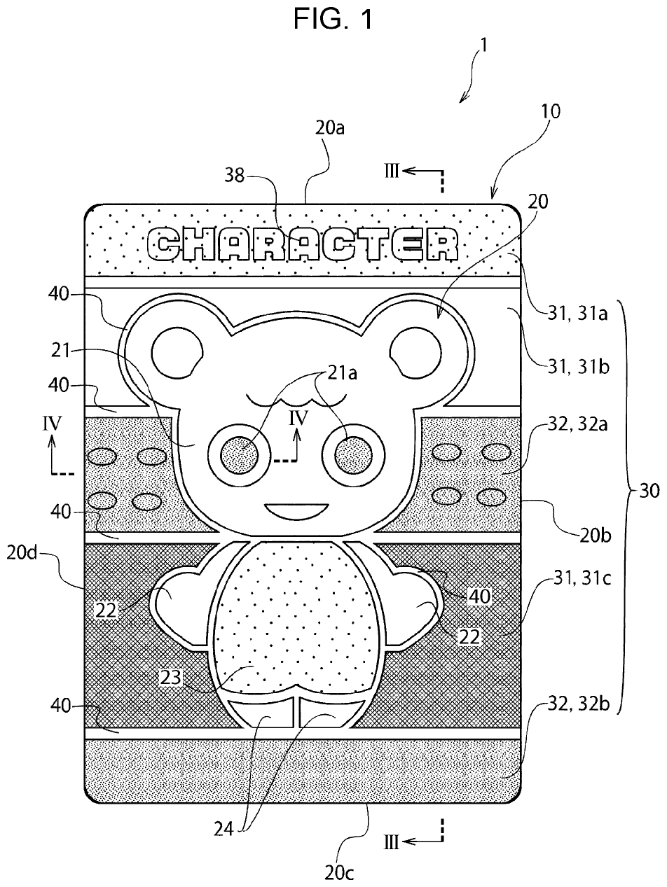

FIG. 1 is a plan view of a confection 1. The confection 1 in FIG. 1, whose material is, for example, chocolate, includes a main body 10 having a rectangular plate shape and including four edges 20a, 20b, 20c, and 20d in plan view. At substantially the center of the main body 10, a character section 20 shaped like, for example, an animal is formed, and a background section 30 is provided around the character section 20.

The character section 20 includes plural parts such as a face part 21, an arm part 22, a trunk part 23, and a leg part 24. Grooves 40 are each provided between respective ones of the parts and divide the parts from one another. In addition, a groove 40 is also provided between the character section 20 and the background section 30 so as to cause the character section 20 to stand out in bold relief against the background section 30.

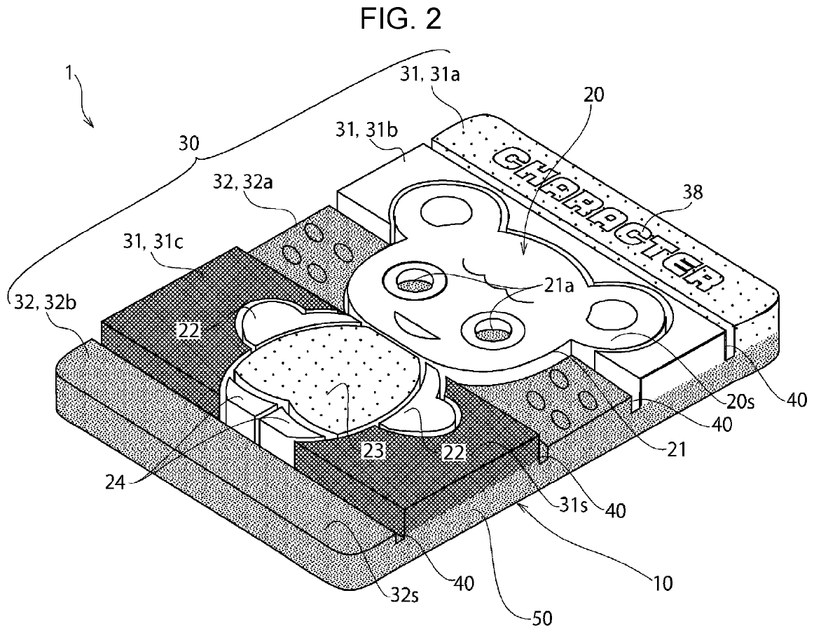

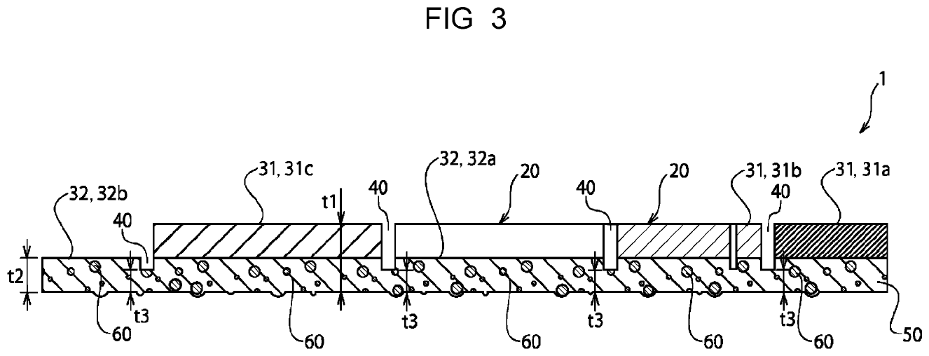

In the present embodiment, the background section 30 includes, for example, divisions of plural strip-shaped portions (in the present embodiment, five portions) that are vertically adjacent to one another and extend horizontally in FIG. 1. The strip-shaped portions differ in coloring or design appropriately and decorate the character section 20. The strip-shaped portions of the background section 30 are broadly classified as first background portions 31 and second background portions 32 by the protrusion height thereof (refer to FIGS. 2 and 3). Two first background portions 31 (31a and 31b) on the upper side and the first background portion 31 (31c) that is the fourth portion from the upper side all differ in coloring and design. In addition, the second background portions 32 (32a and 32b) that are the third portion from the upper side and the lowermost portion have the same coloring but differ in design.

Here, the second background portions 32 are formed by using a first range color such as brown of chocolate. The grooves 40 are also formed by using the first range color. On the other hand, the first background portions 31 are formed by using three types of range colors such as blue, white, and pink that are different from the first range color. The range colors are color-coded by reflecting taste materials included in the chocolates. In the present embodiment, classification is made into four types of colors, that is, blown, blue, white, and pink, and there are four types of tastes accordingly.

FIG. 2 is a perspective view of the confection 1. As FIG. 2 illustrates, the main body 10 includes a base 50 on the bottom side of the main body 10. The character section 20 and the first background portions 31 are each formed in a way in which another material (a material differing in color and taste from the material of the base 50) is layered on one side (upper side) of the base 50 while having a thickness substantially equal to the thickness of the base 50.

As FIG. 2 illustrates, the grooves 40 extending in a left-right direction of the main body 10 are formed so as to reach the right and left edges 20b and 20d and have a groove depth reaching the base 50.

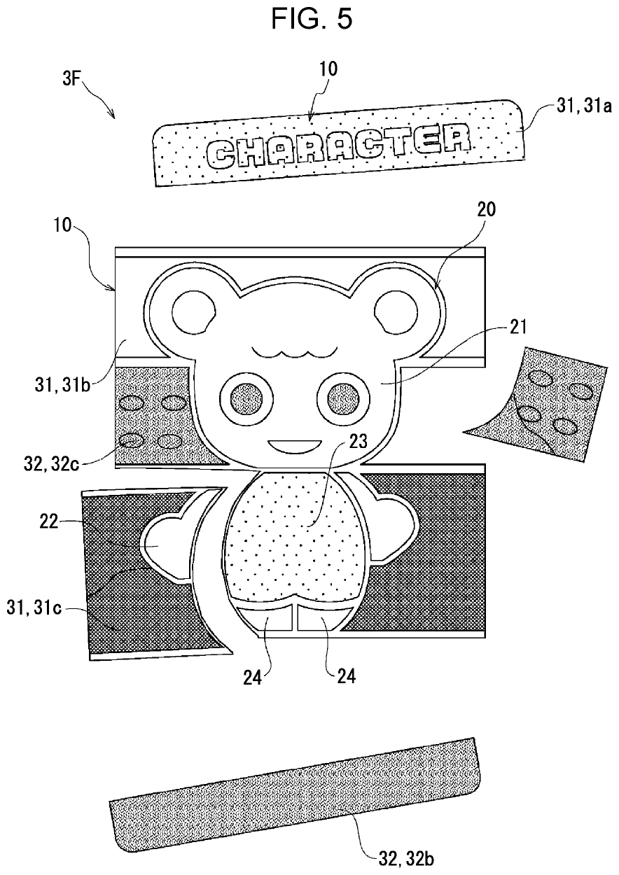

Note that, although the grooves 40 have a depth reaching the base 50 and actually have the same coloring as the base 50 (the first range color that is the same range color as that of the second background portion 32), the grooves 40 are illustrated in white in FIG. 1 (the same applies to FIGS. 5, 6, and 7) for facilitating understanding of the lines in plan view.

As FIG. 2 illustrates, a front surface 20s of the character section 20 does not form a continuous surface with a front surface 31s of the first background portion 31 and with a front surface 32s of the second background portion 32. That is, the groove 40 dividing the character section 20 partitions the front surface 20s of the character section 20 from the front surfaces 31s and 32s of the background section 30.

Note that, in the background section 30, no letters are formed on the second background portions 32 that are formed low when viewed from the front side (in FIG. 2, the upper surface side), and letters 38 are formed on a portion of the first background portions 31 that are formed high when viewed from the front side. Thus, the first background portion 31 on which the letters 38 are formed can emphasize and jazz up the letters 38 at a position at which the first background portion 31 protrudes relative to the second background portions 32.

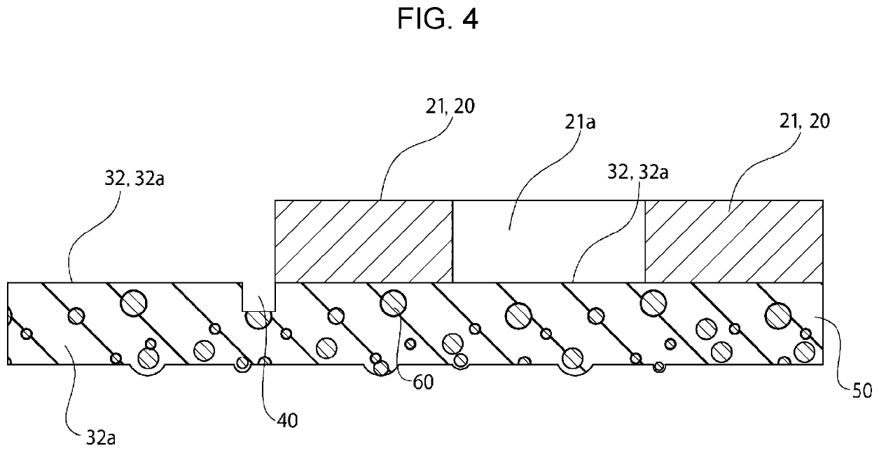

FIG. 3 is a sectional view of a portion along line III-III in FIG. 1, and FIG. 4 is a sectional view of a portion along line IV-IV in FIG. 1. As FIG. 3 illustrates, in the main body 10, the character section 20 and the first background portions 31 are layered on the base 50 as described above. The character section 20 and the first background portions 31 have the same thickness. On the other hand, the second background portions 32 are thinner than the first background portions 31 and constituted only by the base 50.

The first background portions 31 have a thickness larger than the thickness of the second background portions 32 and can have a thickness (t1), for example, in the range from 5.5 mm to 9.0 mm. In this case, the second background portions 32 can have a thickness (t2) in the range from 3.0 mm to 5.4 mm. With such a difference in thickness, the second background portions 32 can be divided into pieces more easily than the character section 20 and the first background portions 31.

The main body 10 is formed as a plate-shaped chocolate and can thus be divided into pieces at an appropriate spot. In particular, the grooves 40, for example, as FIG. 3 illustrates, have a thickness (t3) smaller than the thickness of the second background portions 32. The region of each of the grooves 40 is thinner than the region other than the grooves 40 and is thereby easily divided and separated. Thus, the character section 20 can be broken off the main body 10. Here, as described above, four grooves 40 are formed on the background section 30 and horizontally extend therethrough to the right and left edges 20b and 20d. Thus, the grooves 40 are easily used when the dividing and the breaking off of the character section 20 are started.

As FIG. 3 illustrates, the base 50 is constituted by a chocolate including puffs 60. On the other hand, each of the character section 20 and the first background portions 31 is constituted by a chocolate including no puffs 60. Thus, in addition to the different tastes according to the portions, in the confection 1, the first background portion 31 has a different mouthfeel from the mouthfeel of the second background portion 32.

Note that the lower side (the bottom surface side) of the base 50 includes a high proportion of the puffs 60, and the bottom surface on the back surface side (in FIG. 3, the lower side) of the base 50 has a slightly uneven shape. However, the front surface side (in FIG. 3, the upper side) of the base 50 has a flat surface made of chocolate, being relatively square, including the four edges 20a, 20b, 20c, and 20d, and having few uneven portions that are shaped by the puffs 60, for facilitating layering of the character section 20 and the first background portions 31.

As FIG. 4 illustrates, an eye part 21a of the character section 20 is thinner than and differs in color from other portions. For example, the eye part 21a is provided in the face part 21 in a color such as white and is formed such that the base 50 of brown is visible.

FIG. 5 is a plan view illustrating a state in which the main body 10 is divided into pieces and illustrating a third aspect 3F that is a failure example in which the breaking off of the character section 20 is failed. The state of the breaking off in FIG. 5 is the third aspect 3F in which the character section 20 and the background section 30 have not been divided from each other successfully. The example is an example in which the character section 20 has failed to be broken off in a relatively early stage. In this case, while still connected to each other, the right arm part 22 of the character section 20 and the first background portion 31c are separated from the trunk part 23. The thickness (t1) of the first background portion 31c is the same as the thickness of the arm part 22, and, furthermore, a shoulder portion (an upper portion) of the arm part 22 is shaped to have a small width. Thus, such a failure in separation may be likely to occur when the position where the main body 10 is held and a spot where the main body 10 is pressed during breaking off are not appropriate.

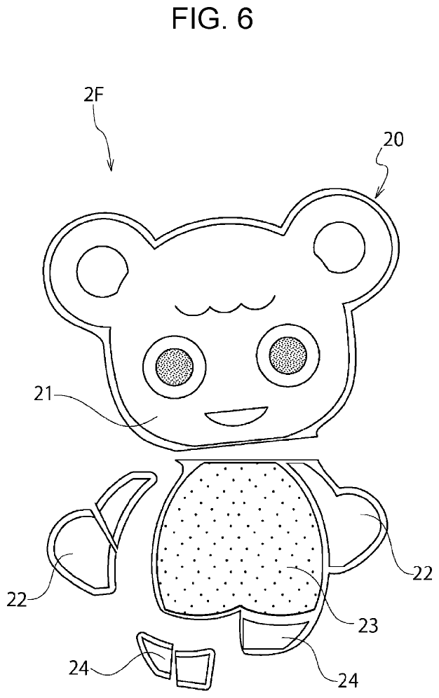

FIG. 6 is a plan view illustrating a state in which the main body 10 is divided into pieces and illustrating a second aspect 2F that is a failure example in which the breaking off of the character section 20 is failed. The state of the breaking off in FIG. 6 is the second aspect 2F in which the character section 20 has been broken off nearly successfully to a certain extent. That is, although the character section 20 and the background section 30 have been able to be separated from each other, the right arm part 22 and the right leg part 24 have been broken. In particular, the arm part 22 and the leg part 24 are small parts of the parts of the character section 20 and, in addition, have the same thickness as the thickness (t1) of the first background portion 31c. Thus, such a failure is likely to occur when a dividing operation by which great external force is applied to the grooves 40 between the arm part 22 and the trunk part 23 and between the leg part 24 and the trunk part 23 is performed.

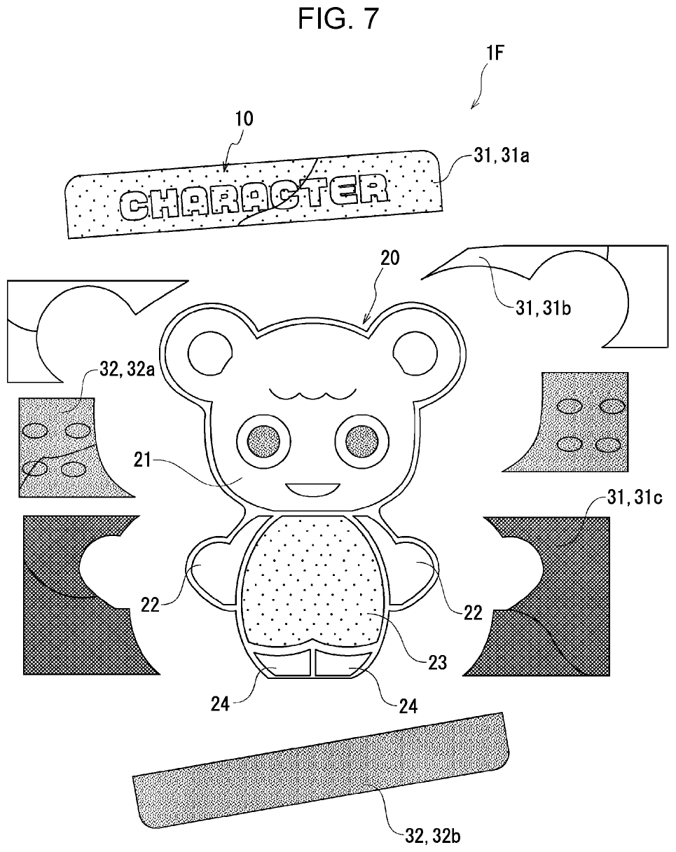

FIG. 7 is a plan view illustrating a state in which the main body 10 is divided into pieces and illustrating a first aspect 1F when the dividing and the breaking off of the character section 20 are successful. The state of the breaking off illustrated in FIG. 7 is a successful example of the first aspect 1F in which the breaking off of the character section 20 has succeeded. In this case, the background section 30 has been separated and broken off successfully at the groove 40 between the character section 20 and the background section 30, that is, at an outer periphery portion of the character section 20. Unlike the above-described failure examples, this case is an example in which the way of holding the main body 10 (a place to which force is applied), the direction where force is applied, the way of bending, and the magnitude of force, for example, have led to the success.

Note that, because the main body 10 of the confection 1 in the present embodiment is formed by chocolate as a main material, the way of breakage of the main body 10 varies depending on the mixing amount of the puffs 60 and the size of the puff 60 and, moreover, subtly varies also depending on the temperature of the main body 10.

As in the first aspect 1F, the second aspect 2F, and the third aspect 3F described above, the way of breakage of the main body 10 is not uniform but subtly varies. Due to such variation, in the confection pieces generated when the character section 20 is broken off, in particular, in the confection pieces in the case of failure, the tastes, the aromas, and the mouthfeels thereof vary from one confection piece to another, and such variations can thus be enjoyed. That is, regarding the separating and the breaking off of the character section 20, while success brings a sense of achievement, separation failure forms confection pieces in various shapes, and the tastes, the aromas, and the mouthfeels, for example, created due to the failure can also be enjoyed.

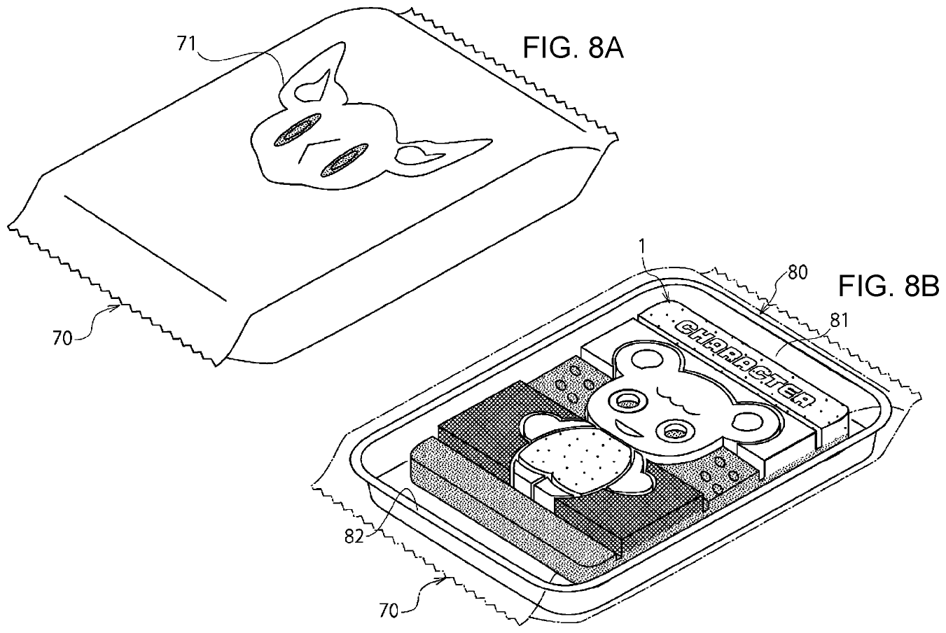

FIGS. 8A and 8B are each a perspective view of a packaging form, that is, FIG. 8A is a perspective view of the appearance of the packaging form, and FIG. 8B is a perspective view of the inside of the packaging form.

For example, as FIG. 8A illustrates, the confection 1, in the providing and selling state thereof, is provided while being packed in a package 70. The main body 10 accommodated inside the package 70 is not visible when packed in the package 70. That is, in the package 70, a material impervious to light covers an accommodated item entirely. As FIG. 8B illustrates, the main body 10 is accommodated inside the package 70 while being accommodated inside an accommodation recess 81 of a container 80 having a protruding rim portion 82 on the outer edge and having a tray shape.

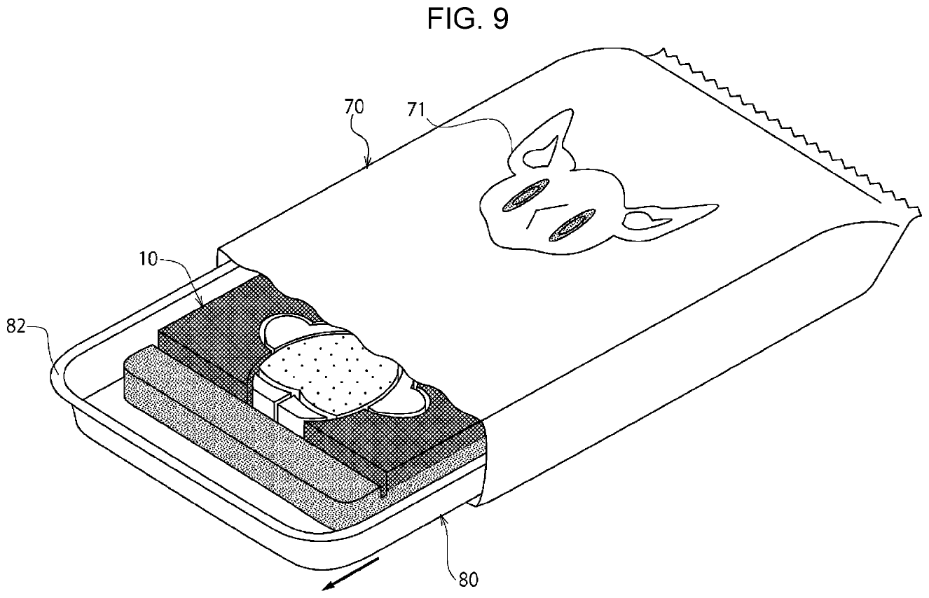

FIG. 9 is a perspective view illustrating a state when the main body 10 of the confection 1 is taken out.

When the main body 10 is taken out, as FIG. 9 illustrates, for example, one side of the package 70 is cut off, and the container 80 is taken out in a way of being pulled out. In the pulling-out operation at this time, the main body 10 can be taken out, for example, in a way in which the package 70 is held by one hand, and the protruding rim portion 82 of the container 80 is pinched with the other hand. In the above-describe manner, the main body 10 can be taken out carefully without being touched with a hand. In addition, by providing the protruding rim portion 82 for the container 80, the overall rigidity of the container 80 is increased even when the container 80 is made of a thin material. Thus, the main body 10 can be protected effectively.

One of the plural types of characters of the character section 20 is depicted on an outer surface of the package 70. On the other hand, as for the character section 20 formed on the base 50 accommodated inside the package 70, plural types of characters are prepared, and one of the characters is layered on the base 50.

There is adopted a random accommodation mode in which the character section 20 of the main body 10 accommodated in the package 70 does not necessarily match a character 71 depicted on the package 70. Thus, as FIG. 9 illustrates, when the main body 10 is taken out from the package 70, there can be provided enjoyment in finding out, for example, whether the character 71 depicted on the package 70 is the same as the character section 20 of the main body 10 or whether the character section 20 inside is a rare character.

As describe above, in the plate-shaped confection 1 provided with the character section 20, the background section 30 has plural thicknesses, and the confection 1 of the present embodiment can thereby achieve three-dimensional presentation.

In the confection 1 of the present embodiment, the first background portions 31 of the background section 30 are made thick and can thereby be more emphasized than the second background portions 32 as the background. In addition, the first background portion 31 and the second background portion 32 are adjacent to each other, thereby achieving three-dimensional presentation between the background portions.

In the confection 1 of the present embodiment, the front surface 20s of the character section 20 does not form a continuous surface with the front surface 31s of the first background portion 31, and separation can thereby be made between the first background portion 31 and the character section 20. The character section 20 is adjacent to each of the background portions 31 and 32 with the groove 40, which has the smallest thickness and is easily broken, interposed therebetween, and division can thereby be made at the groove 40. In particular, the groove 40 is provided around the entire perimeter of the character section 20, and the character section 20 can thereby be divided from and taken out from the main body 10.

In the confection 1 of the present embodiment, in the main body 10, the grooves 40 are easily broken, but the region other than the regions of the grooves 40 can also be broken. Thus, the region other than the grooves 40 may also be broken depending on how force is applied, thereby making the breaking off of the shape of the character section 20 difficult.

In addition, the plural parts of the character section 20 are separated from one another by the grooves 40. Thus, the configuration makes the breaking off difficult when the entire character section 20 is tried to be broken off. As a result, the breaking off of the character section 20 can be enjoyed as a difficult task.

In the confection 1 of the present embodiment, the colors of the confection 1 can be enjoyed by making the range color of the first background portions 31 differ from the range colors of the second background portions 32. In addition, the contour of the character section 20 can be made distinct by making the groove 40 have a color different from the color of the character section 20, that is, for example, the range color of the second background portions 32. In addition, the character section 20 can be jazzed up in a colorful manner by making the parts of the character section 20 have different colors.

In the confection 1 of the present embodiment, in the main body 10, the character section 20, the first background portions 31, and the second background portions 32 are layered on the base 50, and the range color of the base 50 is thus easily used. In addition, the color of the grooves 40 can be the range color of the base 50. In addition, the eye part, for example, can be characterized through color arrangement using the base 50. Moreover, when plural types of characters are available for the character on the base 50, the same base 50 is used for good manufacturability.

In the confection 1 of the present embodiment, the character section 20 is formed at the center of the main body 10. Thus, a process of reaching the character section 20 from the periphery toward a center portion during the course of the process of breaking off can be enjoyed.

In the confection 1 of the present embodiment, ease of division varies between the first background portion 31 and the second background portion 32, and difficulty in the breaking of the background section 30 can thus be presented, unlike a background section whose ease of division is uniform.

In the confection 1 of the present embodiment, the letters are formed on the first background portion 31 having a large thickness and can thereby be emphasized.

In the confection 1 of the present embodiment, the first background portions 31 are formed to include, for example, the upper side edge 20a and the right side edge 20b of the four edges (sides) of the rectangular main body 10. Thus, breaking off (cutting off) can be started, for example, from the regions of the first background portions 31a and 31b.

In the confection 1 of the present embodiment, the grooves 40 serving as dividing lines are provided such that there arise the case where division can be successfully made between the character section 20 and other portions and the case where such division cannot be successfully made, and the region other than the grooves 40 is also breakable. Thus, separating the character section 20 completely can be enjoyed. In addition, a sense of achievement when the character section 20 has been broken off completely can be produced.

In the confection 1 of the present embodiment, the first background portion 31 and the second background portion 32 have different tastes, and both the dividing process and the variety of taste can be enjoyed at the same time. In particular, because the way of breakage always varies, a color and a taste left in a divided piece vary each time, and such variation can thus be enjoyed. In addition, the main body 10 includes the base 50 including the puffs 60, and the mouthfeel, with the taste, can thereby be enjoyed.

In the confection 1 of the present embodiment, the main body 10, by being accommodated in the container 80, is protected during, for example, the transport thereof, and, moreover, is easily taken out when taken out from the package 70. In addition, the main body 10 is not visible due to the package 70, and the type of the character that becomes visible when the package 70 is opened can be enjoyed.

Although one embodiment of the present invention has so far been described above, the present invention can be appropriately modified within the scope of the technical concepts thereof. For example, in the above-described embodiment, the background section 30 has two different thicknesses relative to the thickness of the character section 20. However, the configuration is not the only option, and the background section 30 may have three or more types of thicknesses.

In the above-described embodiment, the confection made mainly from chocolate is given. However, the configuration is not the only option, and there is no particular limitation in the material of the confection as long as the material, such as cookie, can be hardened to some extent.

### Second Embodiment

Hereinafter, a confection that is an embodiment of the present invention will be described with reference to the drawings.

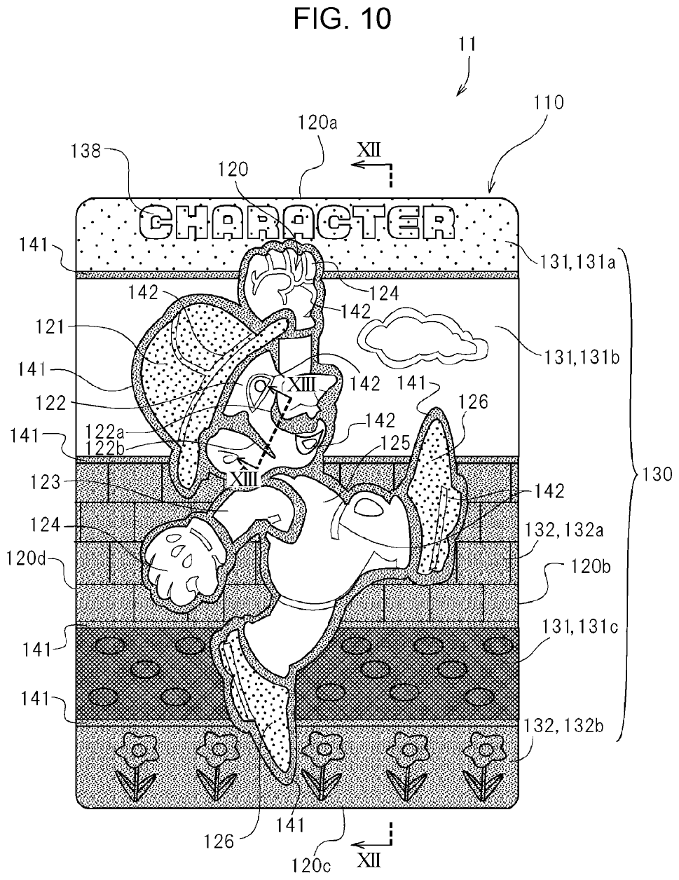

FIG. 10 is a plan view of a confection 11.

The confection 11 in FIG. 10, whose material is, for example, chocolate, includes a main body 110 having a rectangular plate shape and including four edges 120a, 120b, 120c, and 120d (right and left vertical edges 120b and 120d and upper and lower horizontal edges 120a and 120c). At substantially the center of the main body 110, a character section 120, for example, in a lively motion such as a running motion is formed, and a background section 130 is provided around the character section 120.

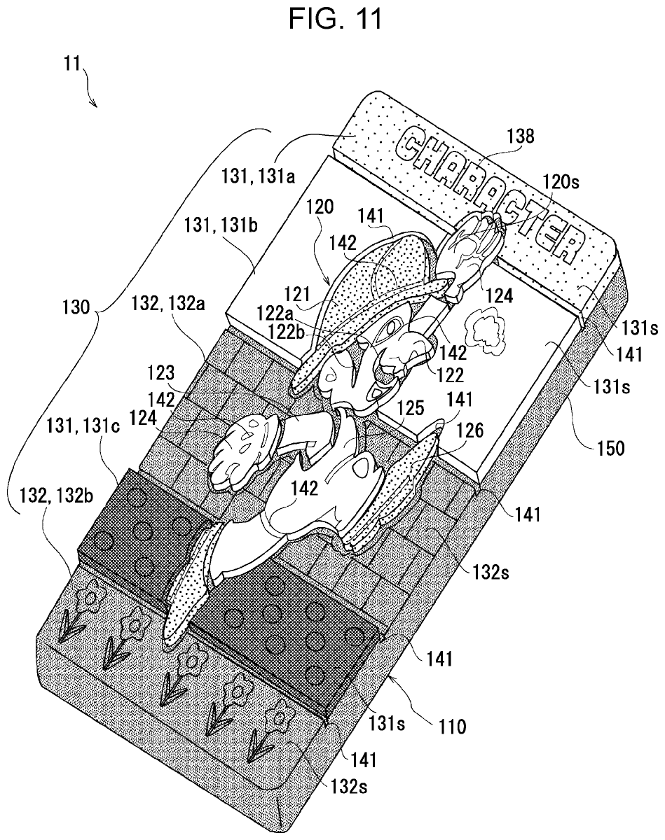

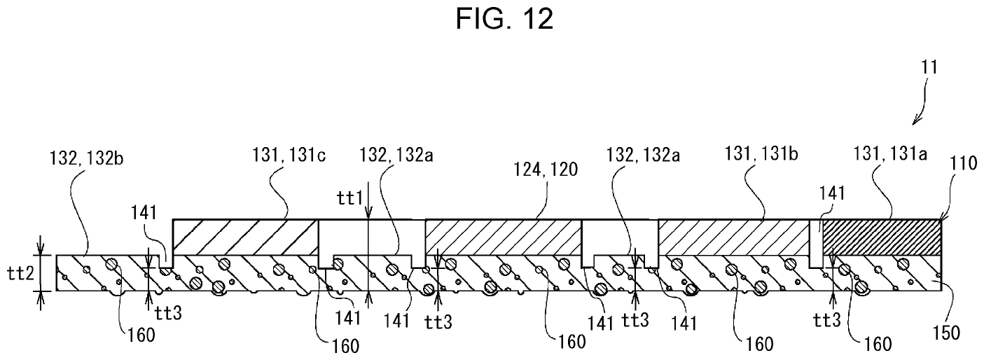

In the present embodiment, the background section 130 includes, for example, divisions of plural strip-shaped portions (in the present embodiment, four portions) that are vertically adjacent to one another and extend horizontally in FIG. 10. The strip-shaped portions appropriately differ in coloring or design and decorate the character section 120. The strip-shaped portions of the background section 130 are broadly classified as first background portions 131 and second background portions 132 by the protrusion height thereof (refer to FIGS. 11 and 12). The first background portions 131 have a first thickness, and the second background portions 132 have a second thickness smaller than the first thickness.

In FIG. 10, two first background portions 131 (131a and 131b) on the upper side and the first background portion 131 (131c) that is the second portion from the lower side all differ in coloring and design. For example, a first pattern, such as a dot pattern, a cloud pattern, or an ellipse pattern, is formed on the first background portion 131. The second background portion 132 (132a) that is the third portion from the upper side and the second background portion 132 (132b) that is the lowermost portion differ in coloring and design from the first background portions 131. For example, a second pattern, such as a brick pattern or a flower pattern, is formed on the second background portion 132.

Here, the second background portions 132 are formed by using, for example, the first range color such as brown of chocolate. A first groove 141 that illustrates the contour of the character section 120 and will be described later is also formed by using the first range color. On the other hand, the first background portions 131 are formed by using, for example, range colors such as blue, white, pink, and light brown that are different from the first range color. The range colors are color-coded by reflecting taste materials included in the chocolates. In the present embodiment, classification is made into four to five types of colors, and there are four to five types of tastes accordingly.

The character section 120 includes plural parts such as a head part 121, a face part 122, an arm part 123, a hand part 124, a trunk part 125 (including a leg part), and a foot part 126. First grooves 141 serving as contour lines between respective ones of the parts are provided. The first groove 141 is formed around the entire periphery of the character section 120 so as to cause the character section 120 to stand out in bold relief against the background section 130.

The hand part 124, the trunk part 125, and the foot part 126 of the character section 120 are depicted so as to lie over the plural background portions of the background section 130. For example, the background section 130 is constituted by a portion (the first background portion 131b) on which a sky is depicted, a portion (the second background portion 132a) on which a brick-style wall is depicted, a portion (the first background portion 131c) on which a road in a stone paving style is depicted, and a portion (the second background portion 132b) on which the garden-style roadside is depicted, and the character section 120 not facing the front is depicted in a way of stepping into and lying across all the background portions of the background section 130. Thus, a lively motion in which the character section 120 runs out of the background is presented. In addition, the surface area of the background section 130 is larger than the surface area of the character section 120, and the depiction of the background section 130 having such a large area is important in view of the presentation of the motion of the character section 120. FIG. 11 is a perspective view of the confection 11.

As FIG. 11 illustrates, the main body 110 includes a base 150 on the bottom side of the main body 110. The character section 120 and the first background portions 131 are each formed in a way in which another material (a material differing in color and taste from the material of the base 150) is layered on one side (upper side) of the base 150 while having an appropriate thickness.

The main body 110 has a rectangular shape as described above, and, as FIG. 10 illustrates, the first grooves 141 dividing the background section 130 into portions are formed between the right and left edges 120b and 120d. In addition, the first grooves 141 have a groove depth reaching the base 150. As FIG. 11 illustrates, a front surface 120s of the character section 120 is positioned higher than a front surface 132s of the second background portion 132 and is positioned at substantially the same height as a front surface 131s of the first background portion 131.

In each of the parts, there are provided second grooves 142 shaped like, for example, the line of a proximal end portion of a brim of a hat in the head part 121, the shapes of a mouth and an eye in the face part 122, the lines of leg parts and trousers in the trunk part 125, the shapes of hands or gloves in the hand parts 124, and the shapes of shoes in the foot parts 126. The depth of the second grooves 142 (the depth viewed from the front surface 120s of the character section 120) is shallower than that of the first grooves 141. As described above, for example, the first groove 141 and the second groove 142 that differ in depth are provided as the grooves.

In the background section 130, letters 138 are formed on at least one of the first background portions 131 and the second background portions 132 and render emphasis on the character. Note that, although the letters 138 are formed by grooves, a material in a color different from the color of a material on the lower side may be layered on the material on the lower side.

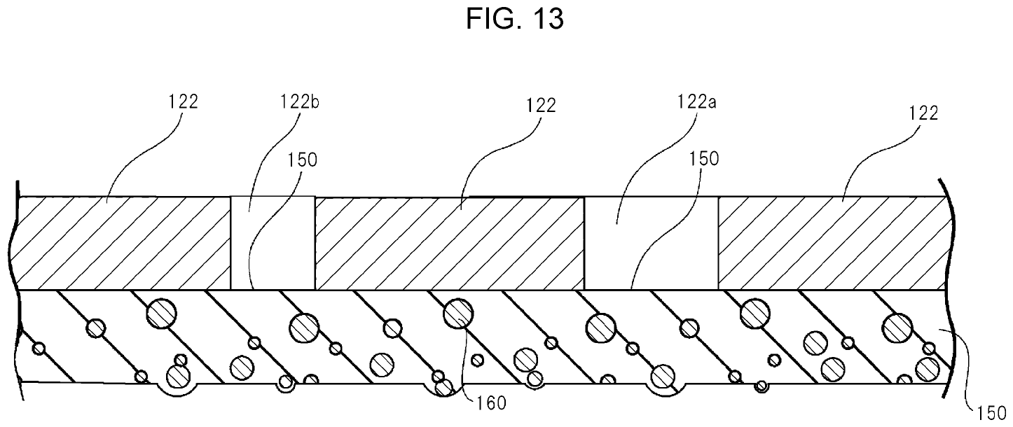

FIG. 12 is a sectional view of a portion along line XII-XII in FIG. 10, and FIG. 13 is a sectional view of a portion along line XIII-XIII in FIG. 10.

As FIG. 12 illustrates, in the main body 110, the character section 120 and the first background portions 131 are layered on the base 150 as described above. The character section 120 and the first background portions 131 have the same thickness. On the other hand, the second background portions 132a and 132b are thinner than the first background portions 131a, 131b, and 131c. In the present embodiment, the second background portions 132a and 132b are constituted only by the base 150.

The first background portions 131 have a thickness larger than the thickness of the second background portions 132 and can have, but not particularly limited to, a thickness (tt1), for example, in the range from 5.5 mm to 9.0 mm. In this case, the second background portions 132 can have a thickness (tt2) in the range from 3.0 mm to 5.4 mm. With such a difference in thickness, the second background portions 132 can be divided more easily than the character section 120 and the first background portions 131.

The main body 110 is formed as a plate-shaped chocolate and can thus be divided into pieces at an appropriate spot. In particular, a thickness (tt3) of the regions of the first grooves 141 is smaller than the thicknesses (the thickness tt1 and the thickness tt2) of the portions other than the first grooves 141, and division and separation are thereby easily made at the first grooves 141. Thus, the character section 120 can be divided from and broken off the main body 110 along the contour shape thereof. Here, as described above, four first grooves 141 are formed on the background section 130 and horizontally extend therethrough to the right and left edges 120b and 120d. Thus, the first grooves 141 can be used when the dividing and the breaking off of the character section 120 are started.

As FIG. 12 illustrates, the base 150 is constituted by a chocolate including puffs 160. On the other hand, each of the character section 120 and the first background portions 131 is constituted by a chocolate including no puffs 160. Thus, in the confection 11, in addition to the different tastes according to the portions, the first background portion 131 has a different mouthfeel from the mouthfeel of the second background portion 132.

Note that the lower side (the bottom surface side) of the base 150 includes a high proportion of the puffs 160, and the bottom surface on the back surface side (in FIG. 12, the lower side) of the base 150 has a slightly uneven shape. However, the front surface side (in FIG. 12, the upper side) of the base 150 has a substantially flat surface made of chocolate with few uneven portions that are formed by the puffs 160.

The face part 122 of the character section 120 includes a mustache part 122a and a sideburn part 122b that are thinner than other portions of the face part 122. For example, as FIG. 13 illustrates, portions of the base 150 are exposed in a long and narrow shape. That is, the mustache part 122a and the sideburn part 122b are formed continuously from the second background portion 132 with the first groove 141 interposed therebetween and are in the same color as the second background portion 132.

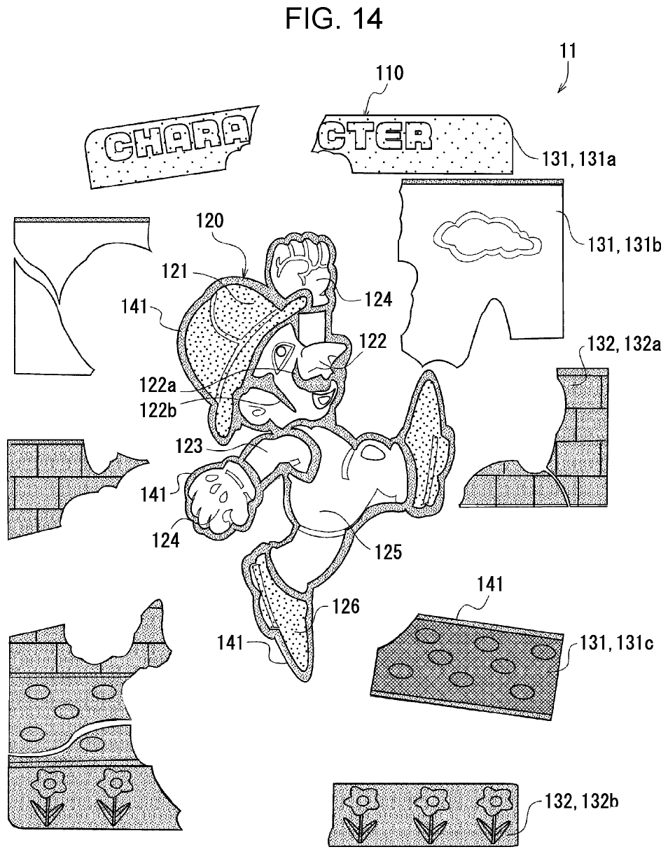

FIG. 14 is a plan view illustrating a state in which the main body 110 is divided into pieces and illustrating a state when the dividing and the cutting off of the character section 120 is successful.

The state of the breaking off illustrated in FIG. 14 is an example in which the breaking off of the character section 120 has succeeded. In this case, the background section 130 has been separated successfully at the first groove 141 between the character section 120 and the background section 130, that is, at an outer periphery portion of the character section 120. Unlike a failure example in which, for example, a neck part or the hand part 124 of the character section 120 has been broken, this case is an example in which the way of holding the main body 110 (a place to which force is applied), the direction where force is applied, the way of bending, and the magnitude of force, for example, have led to the success.

Note that, because the main body 110 of the confection 11 in the present embodiment is formed by chocolate as a main material, the way of breakage of the main body 110 varies depending on the mixing amount of the puffs 160 and the size of the puff 160 and, moreover, subtly varies also depending on the temperature of the main body 110.

Unlike when the character section 120 has been broken off successfully as FIG. 14 illustrates, when the confection 11 has been broken at various places, such a broken confection piece includes the character section 120 and the background section 130 in a mixed state. As a result, the tastes, the aromas, and the mouthfeels of the confection pieces vary from one confection piece to another and can thus be enjoyed, and the tastes, the aromas, and the mouthfeels, for example, created due to the failure of the separating and the cutting off of the character section 120 can be enjoyed.

As describe above, in the confection 11 of the present embodiment, in the plate-shaped confection 11 provided with the character section 120, the background section 130 has plural thicknesses, and the confection 11 of the present embodiment can thereby achieve three-dimensional presentation. Some of the parts of the character section 120 are formed continuously from the second background portion 132, and the second background portion 132 can thus be used in the design of the character section 120.

In the confection 11 of the present embodiment, ease of division varies between the first background portion 131 and the second background portion 132, and difficulty in the breaking of the background section 130 can thus be presented, unlike a background section 130 whose ease of division is uniform.

In the confection 11 of the present embodiment, the character section 120 includes a portion having the same thickness as the first background portion 131 and a portion having the same thickness as the second background portion 132. Thus, the character section 120 can be represented three-dimensionally, and, in particular, a subtle facial expression of the face part can be presented. In addition, the grooves include the first groove 141 and the second groove 142 that differ in groove depth, thereby enabling further intricate expression of the design of the character section 120.

In the confection 11 of the present embodiment, because a portion (the mustache part 122a) formed continuously from the second background portion 132 has a long and narrow shape, for example, the long and narrow portion having an easily broken structure can make the breaking off of the character section 120 difficult.

In the confection 11 of the present embodiment, the colors of the confection 11 can be enjoyed by making the range color of the first background portions 131 differ from the range colors of the second background portions 132. In addition, the contour of the character section 120 can be made distinct by making the first grooves 141 have a color different from the color of the character section 120, that is, for example, the range color of the second background portions 132. In addition, the character section 120 can be jazzed up in a colorful manner by making the parts of the character section 120 have different colors.

In the confection 11 of the present embodiment, the first background portions 131 include at least any one of the edge on one side (upper edge) and the edge on the other side (lower edge) of the main body 110. Thus, when the character section 120 is tried to be broken off, the breaking off can be started from the first background portion 131 that is an edge of the main body 110.

In the confection 11 of the present embodiment, the first groove 141 surrounding the periphery of the character section 120 is a deep groove, and the contour shape of the character section 120 can thereby be easily broken off.

In the confection 11 of the present embodiment, the plural parts of the character section 120 are separated from one another by the first grooves 141, and, when the entire character section 120 is cut off, the cutting off is thus made difficult. As a result, the cutting off of the character section 120 can be enjoyed as a difficult task.

In the confection 11 of the present embodiment, the first groove 141 has a thickness not larger than the thickness of the second background portion 132 and can thereby be easily broken during the breaking off of the character section 120.

In the confection 11 of the present embodiment, the character section 120 and the first background portions 131 are formed by being layered on the base 150, and variations in taste and color can be made by the base 150 and the layered materials thereon. In addition, because the character section 120 is formed on the base 150, the same base 150 can also be used when many different characters are formed.

In the confection 11 of the present embodiment, separating the character section 120 completely can be enjoyed with the first groove 141 provided as a dividing line. In addition, in the main body 110, the first grooves 141 are formed deep and are thus easily broken, but the region other than the regions of the first grooves 141 can also be broken. The region other than the first grooves 141 may also be broken depending on how force is applied, and the cutting off of the shape of the character section 120 is thereby made difficult. Consequently, a sense of achievement when the character section 120 has been cut off completely can be produced.

In the confection 11 of the present embodiment, the first background portion 131 and the second background portion 132 have different tastes, and both the dividing process and the variety of taste can be enjoyed at the same time. In particular, because the way of breakage always varies, a color and a taste left in a divided piece vary each time, and such variation can thus be enjoyed.

In addition, the main body 110 includes the base 150 including the puffs 160, and the mouthfeel, with the taste, can thereby be enjoyed. In addition, the portions in the same color have the same taste, and prediction about a taste based on a color can be enjoyed.

In the confection 11 of the present embodiment, the surface area of the character section 120 is smaller than the total surface area of the first background portions 131 and the second background portions 132, and the configuration thereby facilitates presentation given by using the background section 130.

In the confection 11 of the present embodiment, the letters 138 are formed on the background section 130 and can render emphasis.

In the confection 11 of the present embodiment, the character section 120 does not face the front and is in an aspect representing a motion such as a running motion. Thus, a lively feeling of the character can be created.

In the confection 11 of the present embodiment, the first pattern is formed on the first background portion 131, and the second pattern is formed on the second background portion 132. Thus, the first background portion 131 and the second background portion 132 can provide different background presentations.

Although one embodiment of the present invention has so far been described above, the present invention can be appropriately modified within the scope of the technical concepts thereof. For example, in the above-described embodiment, the background section 130 has two different thicknesses relative to the thickness of the character section 120. However, the configuration is not the only option, and the background section 130 may have three or more types of thicknesses.

In addition, in the above-described embodiment, the first grooves 141 have one depth, and the second grooves 142 have one depth. However, this is not the only option, and, for example, the first grooves 141 may have plural depths, and the second grooves 142 may also have plural depths.

In the above-described embodiment, the confection made mainly from chocolate is given. However, the configuration is not the only option, and there is no particular limitation in the material of the confection as long as the material, such as cookie, can be hardened to some extent.

As described above, the following items are described in the present specification.

(1)

A confection including:
a main body having a plate shape;
a character section formed in the main body; and
a background section formed in the main body, in which
the background section includes a first background portion having a thickness equal to a thickness of the character section and a second background portion having a thickness different from the thickness of the character section.
   (2)

The confection according to (1), in which
the thickness of the first background portion is larger than the thickness of the second background portion.
   (3)

The confection according to (1) or (2), in which
the thickness of the first background portion is in a range from 5.5 mm to 9.0 mm, and
the thickness of the second background portion is in a range from 3.0 mm to 5.4 mm.
   (4)

The confection according to any one of (1) to (3), in which
a front surface of the character section does not form a continuous surface with a front surface of the first background portion.
   (5)

The confection according to any one of (1) to (4), in which
the character section is provided adjacent to the first background portion and the second background portion.
   (6)

The confection according to any one of (1) to (5), in which
the character section is provided adjacent to the first background portion and the second background portion with a groove interposed therebetween.
   (7)

The confection according to (6), in which
the groove has a thickness smaller than the thickness of the second background portion.
   (8)

The confection according to (6) or (7), in which
the groove is provided around an entire periphery of the character section.
   (9)

The confection according to any one of (6) to (8), in which
the main body can be divided at the groove and in a region other than the groove.
   (10)

The confection according to (9), in which
the main body is divided more easily at the groove than in the region other than the groove.
   (11)

The confection according to any one of (6) to (10), in which
the character section includes plural parts, and
the groove is provided between the plural parts.
   (12)

The confection according to any one of (6) to (11), in which
the second background portion is formed by using a first range color, and
the groove is formed by using the first range color.
   (13)

The confection according to (12), in which
the first background portion is formed by using plural range colors different from
the first range color.
   (14)

The confection according to (12) or (13), in which
the character section includes plural parts, and
the character section has plural range colors other than the first range color, from one part to another of the plural parts.
   (15)

The confection according to any one of (1) to (14), in which
the main body includes a base,
the character section and the first background portion are formed by being layered on the base, and
the second background portion is formed only by the base.
   (16)

The confection according to (15), in which
the character section and the first background portion are layered only on a surface on one side of the base.
   (17)

The confection according to (16), in which
the character section includes an eye part, and
the base is visible in the eye part.
   (18)

The confection according to any one of (1) to (17), in which
the character section is formed at a center of the main body.
   (19)

The confection according to any one of (1) to (18), in which
the second background portion is divided more easily than the character section and the first background portion.
   (20)

The confection according to any one of (1) to (19), in which
a letter is formed on the first background portion, and
no letter is formed on the second background portion.
   (21)

The confection according to any one of (1) to (20), in which
the main body includes four edges, and
the first background portion includes at least two edges of the four edges.
   (22)

The confection according to any one of (1) to (21), in which
the main body is tuned into, after a dividing operation, any one of a first aspect in which the character section is divided from the first background portion and the second background portion, a second aspect in which the character section is divided into plural pieces, and a third aspect in which the character section is connected to a portion of the first background portion and a portion of the second background portion.
   (23)

The confection according to any one of (1) to (22), in which
the first background portion has a taste different from a taste of the second background portion.
   (24)

The confection according to any one of (1) to (23), in which
the first background portion has a mouthfeel different from a mouthfeel of the second background portion.
   (25)

The confection according to any one of (1) to (24), in which
the main body includes a base,
the base is constituted by a chocolate including a puff, and
the character section and the first background portion are constituted by a chocolate including no puff.
   (26)

The confection according to (25), in which
the character section has plural types, and one of the plural types is layered on the base.
   (27)

The confection according to any one of (1) to (26), further including:
a package; and a container, in which
the character section is packed in and made invisible by the package with the main body being accommodated in the container.
   (1)

A confection including:
a main body having a plate shape;
a character section formed in the main body and including plural parts; and
a background section formed in the main body, in which
the background section includes a first background portion having a thickness equal to a first thickness and a second background portion having a thickness equal to a second thickness that is different from the first thickness, and
a portion of the plural parts is formed continuously from the second background portion.
   (2)

The confection according to (1), in which
the first thickness is larger than the second thickness.
   (3)

The confection according to (1) or (2), in which
the portion of the plural parts formed continuously from the second background portion has the second thickness.
   (4)

The confection according to any one of (1) to (3), in which
the character section includes a portion having the first thickness.
   (5)

The confection according to any one of (1) to (4), in which
the portion of the plural parts formed continuously from the second background portion is a portion of a face part constituting the character section.
   (6)

The confection according to any one of (1) to (5), in which
the portion of the plural parts formed continuously from the second background portion has a long and narrow shape.
   (7)

The confection according to any one of (1) to (6), in which
the second background portion is formed by using a first range color, and
the portion of the plural parts formed continuously from the second background portion is formed by using the first range color.
   (8)

The confection according to (7), in which
the first background portion is formed by using a range color different from the first range color.
   (9)

The confection according to (7) or (8), in which
the character section has plural range colors including the first range color.
   (10)

The confection according to any one of (1) to (9), in which
the first background portion includes at least any one of an edge on one side and an edge on the other side of the main body, and
the second background portion is formed in a region not including at least any one of the edge on the one side and the edge on the other side of the main body.
   (11)

The confection according to any one of (1) to (10), in which
the second background portion is formed in a region without the first background portion and the character section.
   (12)

The confection according to any one of (1) to (11), in which
a first groove is formed around an entire periphery of the character section.
   (13)

The confection according to (12), in which
a second groove is formed within the character section.
   (14)

The confection according to (13), in which
the first groove is a groove deeper than the second groove.
   (15)

The confection according to (13) or (14), in which
the main body can be divided at the first groove and the second groove, and
the first groove is divided more easily than the second groove.
   (16)

The confection according to any one of (13) to (15), in which
the first groove is formed by using a first range color, and
the second groove is formed by using a range color different from the first range color.
   (17)

The confection according to any one of (13) to (16), in which
the character section includes plural parts, and
the first groove is formed between the plural parts.
   (18)

The confection according to any one of (12) to (17), in which
the first groove has a thickness not larger than the thickness of the second background portion.
   (19)

The confection according to any one of (1) to (18), in which
the main body includes a base,
the character section and the first background portion are formed by being layered on the base, and
the second background portion is formed only by the base.
   (20)

The confection according to (19), in which
the base is constituted by a chocolate including a puff, and
the character section and the first background portion are constituted by a chocolate including no puff.
   (21)

The confection according to any one of (1) to (20), in which
the character section, the first background portion, and the second background portion have the same taste when having the same range color and have different tastes when having different range colors.
   (22)

The confection according to any one of (1) to (21), in which
the character section includes a portion positioned within the first background portion.
   (23)

The confection according to any one of (1) to (22), in which
a surface area of the character section is smaller than a total surface area of the first background portion and the second background portion.
   (24)

The confection according to any one of (1) to (23), in which
a letter portion is formed on at least any one of the first background portion and the second background portion.
   (25)

The confection according to any one of (1) to (24), in which
the character section is in an aspect in which the character section faces in a direction other than a front-facing direction.
   (26)

The confection according to any one of (1) to (25), in which
the character section is in an aspect representing a motion.
   (27)

The confection according to any one of (1) to (26), in which
a first pattern is formed on the first background portion, and a second pattern is formed on the second background portion.

What is claimed is:

1. A confection comprising:
a main body having a plate shape;
a character section formed in the main body; and
a background section formed in the main body, wherein
the background section includes a first background portion having a thickness equal to a thickness of the character section and a second background portion having a thickness different from the thickness of the character section.

2. The confection according to claim 1, wherein the thickness of the first background portion is larger than the thickness of the second background portion.

3. The confection according to claim 2, wherein a front surface of the character section does not form a continuous surface with a front surface of the first background portion.

4. The confection according to claim 3, wherein the character section is provided adjacent to the first background portion and the second background portion.

5. The confection according to claim 4, wherein the character section is provided adjacent to the first background portion and the second background portion with a groove interposed therebetween.

6. The confection according to claim 5, wherein the groove has a thickness smaller than the thickness of the second background portion.

7. The confection according to claim 6, wherein the groove is provided around an entire periphery of the character section.

8. The confection according to claim 7, wherein the main body can be divided at the groove and in a region other than the groove.

9. The confection according to claim 8, wherein the main body is divided more easily at the groove than in the region other than the groove.

10. The confection according to claim 9, wherein the character section includes a plurality of parts, and the groove is provided between the plurality of parts.

11. The confection according to claim 1, wherein
the main body includes a base,
the character section and the first background portion are formed by being layered on the base, and
the second background portion is formed only by the base.

12. The confection according to claim 11, wherein the character section includes an eye part, and the base is visible in the eye part.

13. The confection according to claim 1, wherein the second background portion is divided more easily than the character section and the first background portion.

14. The confection according to claim 1, wherein the main body includes four edges, and the first background portion includes at least two edges of the four edges.

15. The confection according to claim 1, wherein the main body is tuned into, after a dividing operation, any one of a first aspect in which the character section is divided from the first background portion and the second background portion, a second aspect in which the character section is divided into a plurality of pieces, and a third aspect in which the character section is connected to a portion of the first background portion and a portion of the second background portion.

16. The confection according to claim 1, wherein the main body includes a base, the base is constituted by a chocolate including a puff, and the character section and the first background portion are constituted by a chocolate including no puff.

17. The confection according to claim 1, wherein the character section includes a plurality of parts, the first background portion has a first thickness, and the second background portion has a second thickness different from the first thickness, and a portion of the plurality of parts is formed continuously from the second background portion.

18. The confection according to claim 17, wherein the first thickness is larger than the second thickness.

19. The confection according to claim 18, wherein the portion of the plurality of parts formed continuously from the second background portion has the second thickness.

20. The confection according to claim 19, wherein the character section includes a portion having the first thickness.

21. The confection according to claim 17, wherein the portion of the plurality of parts formed continuously from the second background portion is a portion of a face part constituting the character section.

22. The confection according to claim 17, wherein the portion of the plurality of parts formed continuously from the second background portion has a long and narrow shape.
